(19) United States
(12) Patent Application Publication
(10) Pub. No.: US 2013/0014438 A1
(43) Pub. Date: Jan. 17, 2013

(54) HANGING FLOWERPOT STRUCTURE

(71) Applicant: Po An TENG, Shenzhen (CN)

(72) Inventor: Po An TENG, Shenzhen (CN)

(21) Appl. No.: 13/349,702

(22) Filed: Jan. 13, 2012

(30) Foreign Application Priority Data
Jul. 14, 2011 (CN) 201120248756.X

(51) Int. Cl. A01G 9/02

(52) U.S. Cl. 47/67

(57) ABSTRACT

A hanging flowerpot structure includes a flowerpot body which has an engaging seat at one side wall and an engaging post at an opposing side wall. Through engagement of the engaging seats and the engaging posts of a plurality of flowerpot bodies, the flowerpot bodies can be connected steady. A hook lug of a rear wall of the flowerpot body is used to hook a wall. An automatic watering hose is engaged in engaging recesses of the two side walls of the flowerpot body to guide water into the flowerpot body. The excess water is drained from a drain hole of a bottom of the flowerpot body to the lower flowerpot body to save water. The present invention is convenient for use and stable in configuration.

### BACKGROUND OF THE INVENTION

1. Field of the Invention

The present invention relates to a hanging flowerpot structure, and more particularly to a hanging flowerpot structure for gardening.

2. Description of the Prior Art

A conventional hanging flowerpot structure is composed of a bedplate and a plurality of flowerpot bodies. The bedplate has a plurality of accommodation holes to receive the flowerpot bodies. A number of bedplates are assembled to form a planting wall. The conventional hanging flowerpot structure has the following drawbacks.

1. Inconvenient for use. The flowerpot bodies cannot be direct connected with each other and cannot be arranged in different shapes. It must cooperate with the bedplate, so it is not convenient for use.

2. Unstable configuration. The flowerpot body doesn't have an interconnection structure. The flowerpot bodies cannot be direct connected with each other. When in use, the flowerpot bodies cannot be positioned steady, so its configuration is unstable.

Accordingly, the inventor of the present invention has devoted himself based on his many years of practical experiences to solve these problems.

### SUMMARY OF THE INVENTION

The primary object of the present invention is to provide a hanging flowerpot structure which comprises a flowerpot body. The flowerpot body has two side walls, an inclined front wall, a rear wall, and a bottom. One of the two side walls comprises an engaging seat at an outer side thereof. The other of the two side walls comprises an engaging post at an outer side thereof. The two side walls each have an engaging recess at a rear upper end thereof. The two side walls each have an insertion hole seat at a front inner side thereof. The rear wall has a hook lug. The bottom has a connection hole seat and a drain hole. When a number of flowerpot bodies are transversely connected, the engaging seat of the side wall of one flowerpot body is pivotally connected with the engaging post of the side wall of the next flowerpot body. When a number of flowerpot bodies are vertically connected, a plurality of connection poles are inserted in the insertion hole seats of the side walls. Upper ends of the connection poles are connected to the insertion hole seats of the upper flowerpot bodies. Through engagement of the engaging seats and the engaging posts of the flowerpot bodies, the flowerpot bodies can be connected steady. The hook lug of the rear wall of the flowerpot body is used to hook a wall. An automatic watering hose is engaged in the engaging recesses of the two side walls of the flowerpot body to guide water into the flowerpot body. The excess water is drained from the drain hole of the bottom to the lower flowerpot body so as to save water. The present invention is convenient for use and stable in configuration.

### BRIEF DESCRIPTION OF THE DRAWINGS

FIG. 1 is a perspective view of the present invention;

FIG. 2 is a bottom view of the present invention;

FIG. 3 is a schematic view of the present invention in a first use state;

FIG. 4 is a schematic view of the present invention in a second use state;

FIG. 5 is a schematic view of the present invention in a third use state; and

FIG. 6 is a schematic view of an embodiment of the present invention.

### DETAILED DESCRIPTION OF THE PREFERRED EMBODIMENTS

Embodiments of the present invention will now be described, by way of example only, with reference to the accompanying drawings.

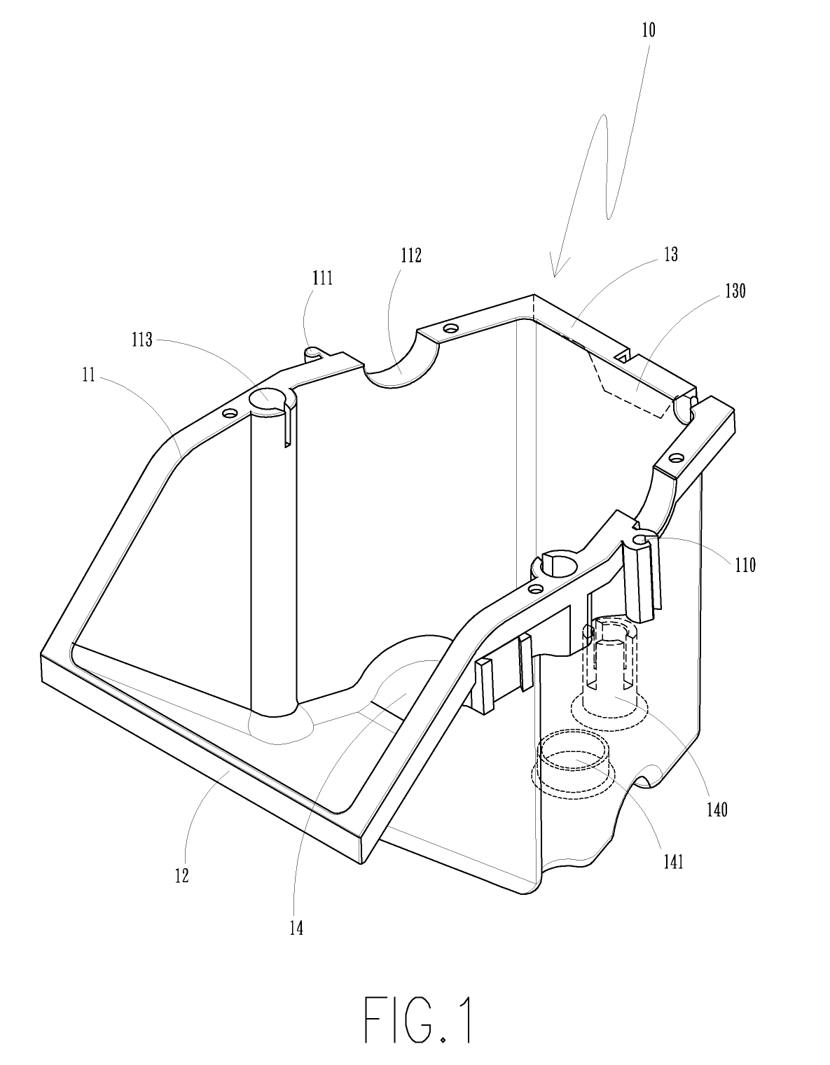

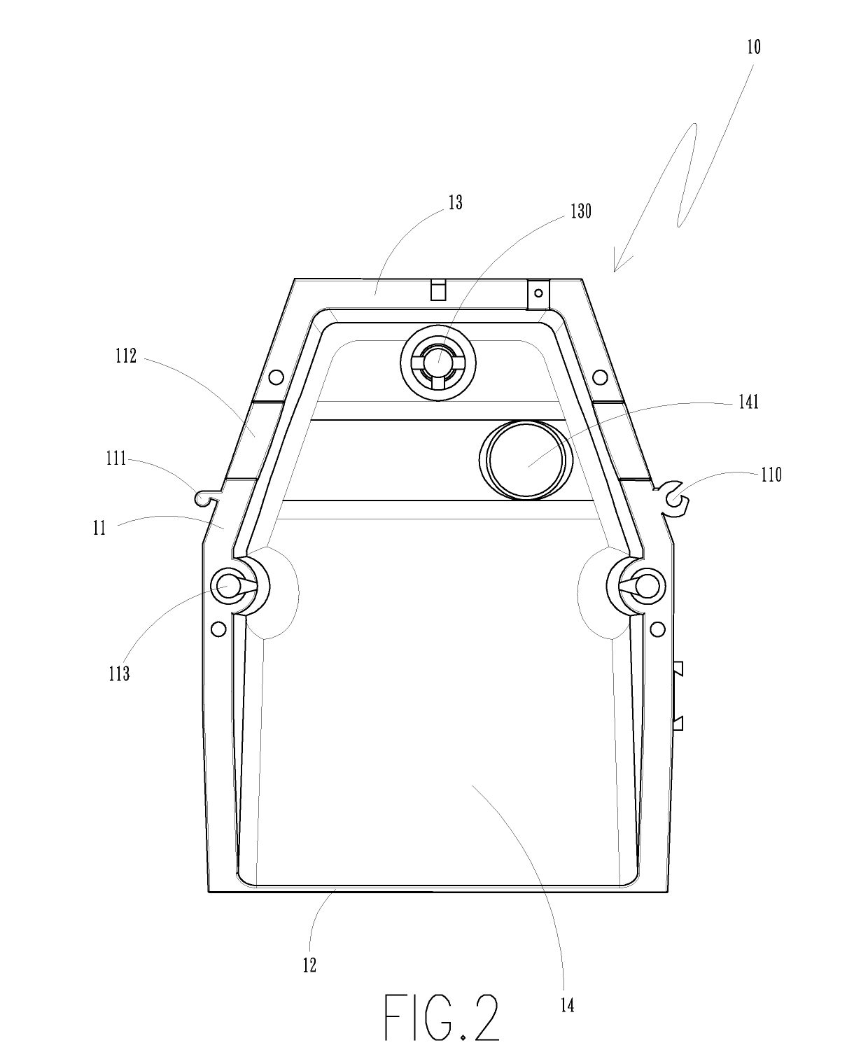

As shown in FIG. 1 and FIG. 2, the hanging flowerpot of the present invention comprises a flowerpot body (10). The flowerpot body (10) has two side walls (11), an inclined front wall (12), a rear wall (13), and a bottom (14). One of the two side walls (11) comprises an engaging seat (110) at an outer side thereof. The other of the two side walls (11) comprises an engaging post (111) at an outer side thereof. The two side walls (11) each have an engaging recess (112) at a rear upper end thereof. The two side walls (11) each have an insertion hole seat (113) at a front inner side thereof. The rear wall (13) has a hook lug (130). The bottom (14) has a connection hole seat (140) and a drain hole (141).

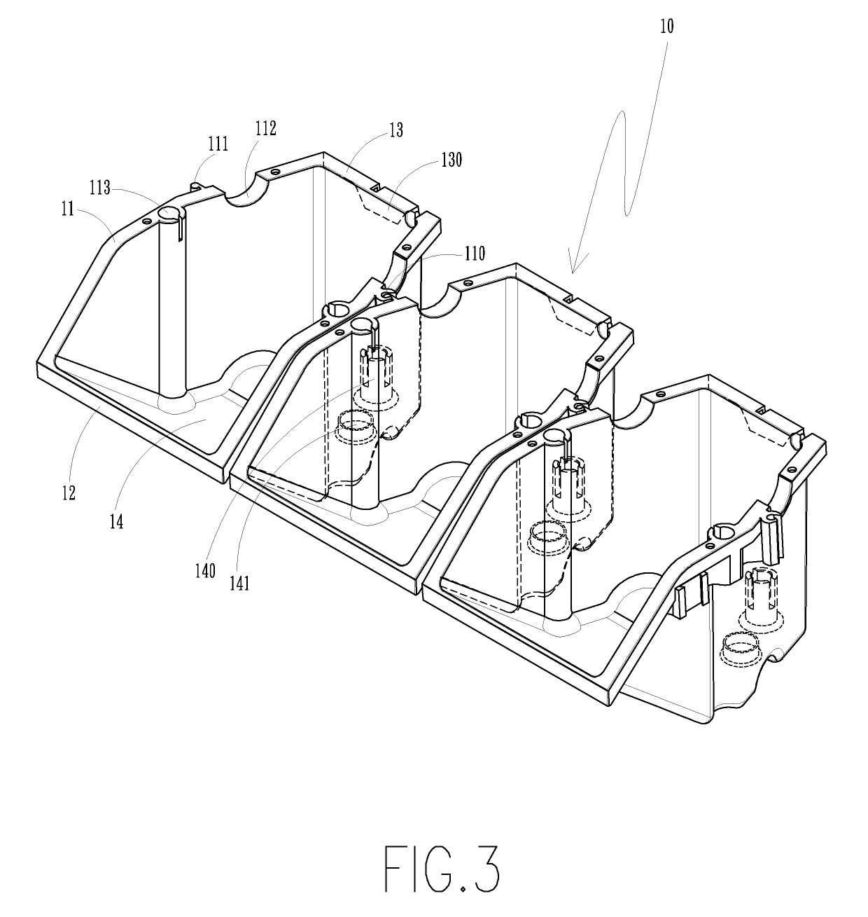

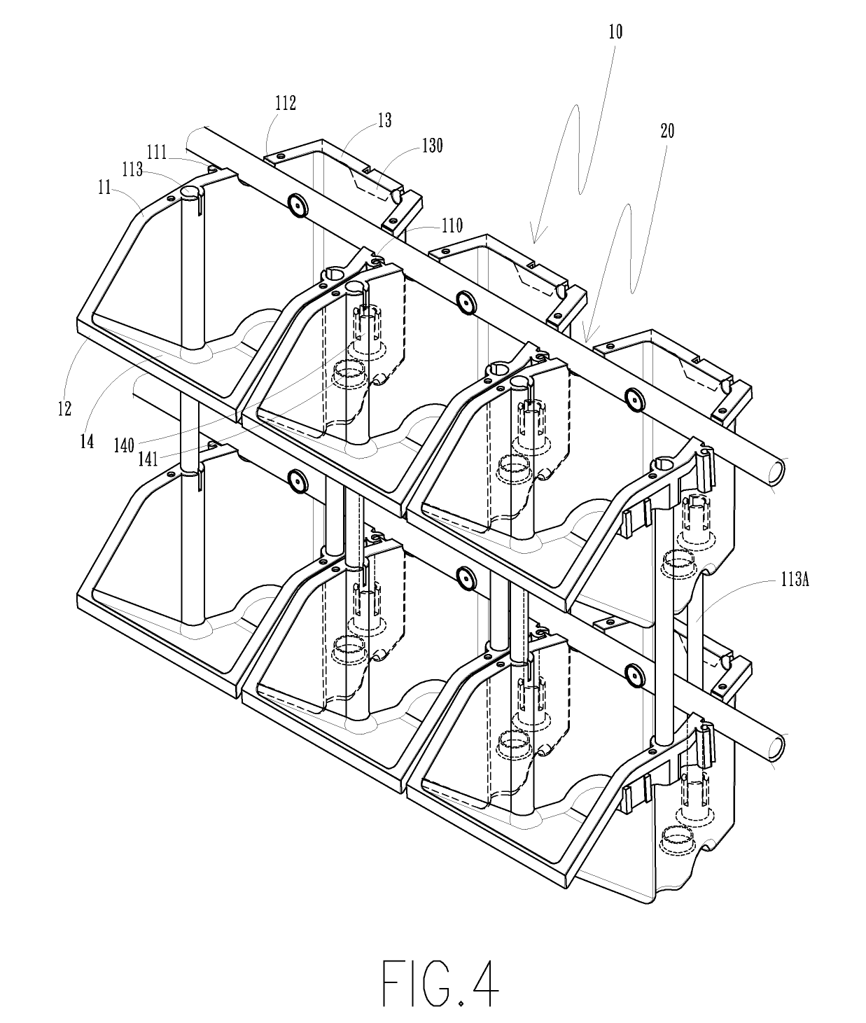

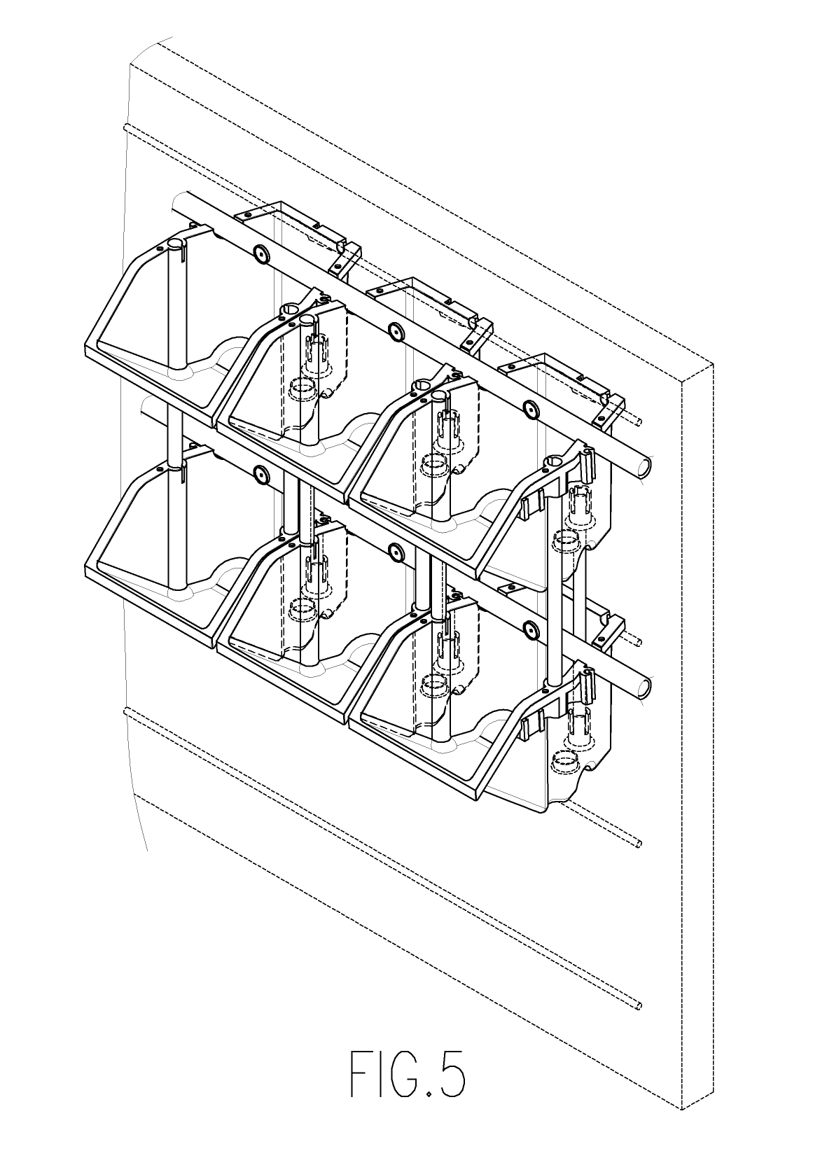

FIG. 2 is a bottom view of the present invention. FIG. 3, FIG. 4 and FIG. 5 are schematic views of the present invention when in use. When a number of flowerpot bodies (10) are transversely connected, the engaging seat (110) of the side wall (11) of one flowerpot body (10) is pivotally connected with the engaging post (111) of the side wall (11) of the next flowerpot body (10). When a number of flowerpot bodies (10) are vertically connected, a plurality of connection poles (113A) are inserted in the insertion hole seats (113) of the side walls (11). Upper ends of the connection poles (113A) are connected to the insertion hole seats (113) of the flowerpot bodies (10) above. Through engagement of the engaging seats (110) and the engaging posts (111) of the flowerpot bodies (10), the flowerpot bodies (10) can be connected steady and disassembled quickly. The hook lug (130) of the rear wall (13) of the flowerpot body (10) is used to hook a wall. An automatic watering hose (20) is engaged in the engaging recesses (112) of the two side walls (11) of the flowerpot body (10) to guide water into the flowerpot body (10). The excess water is drained from the drain hole (141) of the bottom (14) to the lower flowerpot body (10) to save water. The present invention is convenient for use and stable in configuration.

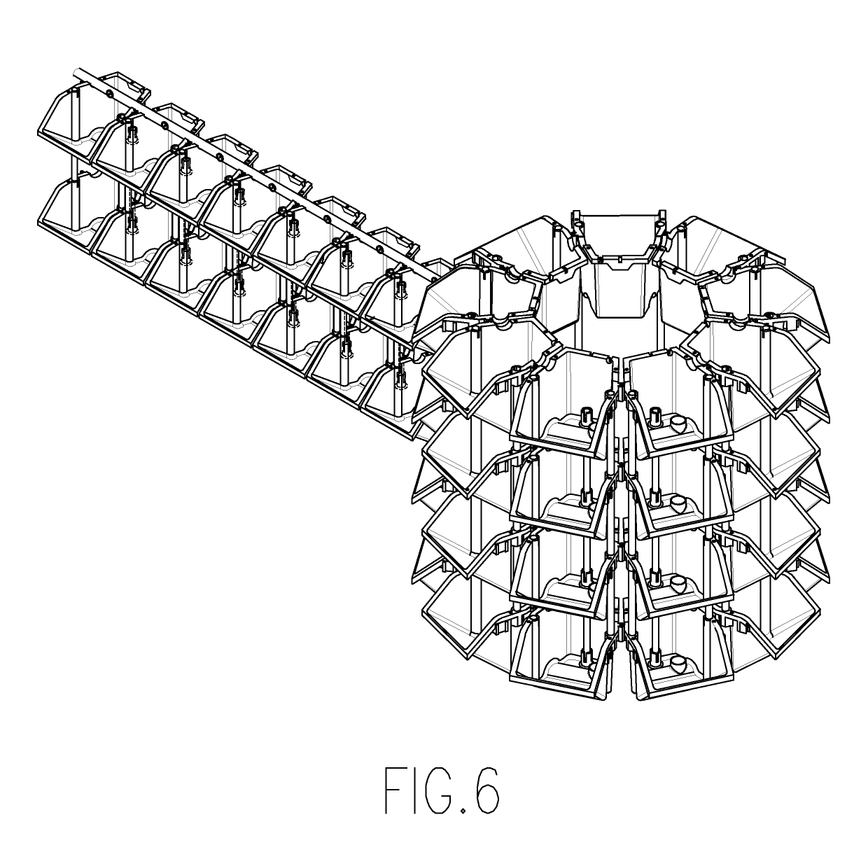

FIG. 6 is a schematic view of an embodiment of the hanging flowerpot of the present invention, which has the same configuration as shown in FIG. 1 and FIG. 2. A number of flowerpot bodies (10) are transversely connected, and the engaging seat (110) of the side wall (11) of one flowerpot body (10) is pivotally connected with the engaging post (111) of the side wall (11) of the next flowerpot body (10). A number of flowerpot bodies (10) are vertically connected, a plurality of connection poles (113A) are inserted in the insertion hole seats (113) of the side walls (11). Upper ends of the connection poles (113A) are connected to the insertion hole seats (113) of the upper flowerpot bodies (10). The flowerpot bodies (10) are arranged in a circle or in a line, enhancing various arrangements of the present invention.

The advantages of the present invention are as follow:

1. Convenient for use. The flowerpot bodies can be assembled with ease to form different shapes (such as circle, rectangle or the like) according to the size of the plants. The watering hose provides an automatic function to water the plants, which can be disassembled quickly and convenient for use.

2. Having stable configuration. Through engagement of the engaging seat and the engaging post, the flowerpot bodies can be connected steady against bad weather. The connection between the flowerpot bodies is firm and stable.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A hanging flowerpot structure, comprising:
a flowerpot body, the flowerpot body having two side walls, an inclined front wall, a rear wall, and a bottom, one of the two side walls comprising an engaging seat at an outer side thereof, the other of the two side walls comprising an engaging post at an outer side thereof, the two side walls each having an engaging recess at a rear upper end thereof, the bottom having a connection hole seat and a drain hole.

2. The hanging flowerpot structure as claimed in claim 1, wherein the rear wall has a hook lug.

3. The hanging flowerpot structure as claimed in claim 1, wherein the engaging recess is provided with an automatic watering hose.

4. The hanging flowerpot structure as claimed in claim 1, wherein a plurality of flowerpot bodies are connected in the form of circle or rectangle by engagement of the engaging seat and the engaging post.

5. A hanging flowerpot structure, comprising:
a plurality flowerpot bodies each having two side walls, an inclined front wall, a rear wall, and a bottom, one of the two side walls comprising an engaging seat at an outer side thereof, the other of the two side walls comprising an engaging post at an outer side thereof, the two side walls each having an engaging recess at a rear upper end thereof, the two side walls each having an insertion hole seat at a front inner side thereof, the bottom having a connection hole seat and a drain hole, wherein when the plurality of flowerpot bodies are transversely connected, the engaging seat of the side wall of one flowerpot body is pivotally connected with the engaging post of the side wall of the next flowerpot body, wherein when the plurality of flowerpot bodies are vertically connected, a plurality of connection poles are inserted in the insertion hole seats of the side walls and upper ends of the connection poles are connected to the insertion hole seats of the upper flowerpot bodies.

6. The hanging flowerpot structure as claimed in claim 5, wherein the rear wall has a hook lug.

7. The hanging flowerpot structure as claimed in claim 5, wherein the engaging recess is provided with an automatic watering hose.

8. The hanging flowerpot structure as claimed in claim 5, wherein the plurality of flowerpot bodies are connected in the form of circle or rectangle by engagement of the engaging seat and the engaging post.
